(19) United States
(12) Patent Application Publication
(10) Pub. No.: US 2017/0208080 A1
(43) Pub. Date: Jul. 20, 2017

(54) COMPUTER-READABLE RECORDING MEDIUM, DETECTION METHOD, AND DETECTION APPARATUS

(71) Applicant: FUJITSU LIMITED, Kawasaki-shi (JP)

(72) Inventors: Yoshinori Sakamoto, Kawasaki (JP); Masazumi Matsubara, Machida (JP); Kenji KOBAYASHI, Kawasaki (JP); Yusuke KOYANAGI, Kawasaki (JP)

(73) Assignee: FUJITSU LIMITED, Kawasaki-shi (JP)

(21) Appl. No.: 15/376,815

(22) Filed: Dec. 13, 2016

(30) Foreign Application Priority Data
Jan. 15, 2016 (JP) 2016-006455

(51) Int. Cl. H04L 29/06; G06N 99/00

(52) U.S. Cl. CPC H04L 63/1425; G06N 99/005

(57) ABSTRACT

A non-transitory computer-readable recording medium stores therein a detection program that causes a computer to execute a process including: extracting a predetermined event from events included in a past log and extracting a plurality of associated events associated with the predetermined event, for each of the predetermined event, over a predetermined time width designating the predetermined event as a starting point; creating pattern data corresponding to the predetermined event and the associated events; constructing a learning model in which the pieces of pattern data are connected in chronological order of the predetermined event; and detecting abnormality based on a collation result between the learning model and event data input according to an occurring event.

### CROSS-REFERENCE TO RELATED APPLICATION

This application is based upon and claims the benefit of priority of the prior Japanese Patent Application No. 2016-006455, filed on Jan. 15, 2016, the entire contents of which are incorporated herein by reference.

### FIELD

The embodiment discussed herein is related to a computer-readable recording medium, a detection method, and a detection apparatus.

### BACKGROUND

Conventionally, in a monitoring target system such as a large-scale computer system and a network system, detection of abnormality (anomaly) such as system trouble due to a cyber attack or the like has been performed. In the anomaly detection, for example, time-series data in the past in the system is converted into metadata and stored as the past metadata. Further, metadata of the real-time time-series data in the system is generated and collated with the past metadata, thereby performing detection of the system trouble or the like.

However, in the conventional technique described above, it is difficult to detect abnormality accompanied by an intermittent and long-term event.

For example, as the abnormality accompanied by an intermittent and long-term event, there is abnormality due to an advanced targeted attack associated with an e-mail and a website, and as an example, there is abnormality due to an exchanging type targeted e-mail attack. In the exchanging type targeted e-mail attack, an e-mail interval from an attacker to a target may extend over several days.

In this manner, when the e-mail from the attacker to the target is delivered intermittently and for a long period of time, various different events generated in between, the e-mails may be mixed in the past time-series data. Therefore, when collation with the time-series data obtained in real time is performed, detection accuracy of abnormality may decrease due to a mismatch with the various different events generated in between the e-mails. Further, a data amount of the past time-series data to be held for abnormality detection becomes very large, and it becomes difficult to perform the collation at a high speed.

### SUMMARY

According to an aspect of an embodiment, a non-transitory computer-readable recording medium stores therein a detection program that causes a computer to execute a process including: extracting a predetermined event from events included in a past log and extracting a plurality of associated events associated with the predetermined event, for each of the predetermined event, over a predetermined time width designating the predetermined event as a starting point; creating pattern data corresponding to the predetermined event and the associated events; constructing a learning model in which the pieces of pattern data are connected in chronological order of the predetermined event; and detecting abnormality based on a collation result between the learning model and event data input according to an occurring event,

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration example of a detection apparatus according to an embodiment;

FIG. 2 is an explanatory diagram of an outline of construction of a learning model and anomaly detection;

FIG. 3 is an explanatory diagram of the learning model;

FIG. 4A is flowchart illustrating an example of a process associated with the construction of the learning model;

FIG. 4B is flowchart illustrating an example of a process associated with the construction of the learning model;

FIG. 5 is an explanatory diagram of definition and rule information;

FIG. 6 is an explanatory diagram of a part management table and an anomaly pattern;

FIG. 7 is an explanatory diagram of compression of the anomaly pattern;

FIG. 8 is an explanatory diagram of merge of common parts;

FIG. 9 is a flowchart illustrating an example of a process associated with the anomaly detection;

FIG. 10 is an explanatory diagram of an example of abnormality detection;

FIG. 11 is an explanatory diagram of abnormality detection in an exchanging type targeted e-mail attack; and

FIG. 12 is a block diagram illustrating an example of a hardware configuration of the detection apparatus according to the embodiment.

### DESCRIPTION OF EMBODIMENT

Preferred embodiments of the present invention will be explained with reference to accompanying drawings. In the embodiments, constituent elements having the same functions are denoted by like reference signs and redundant explanations thereof will be omitted. The computer-readable recording medium, the detection method, and the detection apparatus described in the following embodiments are only examples and the embodiments are not limited thereto. Each of the embodiments described below may be combined appropriately within a scope which is not contradicting to each other.

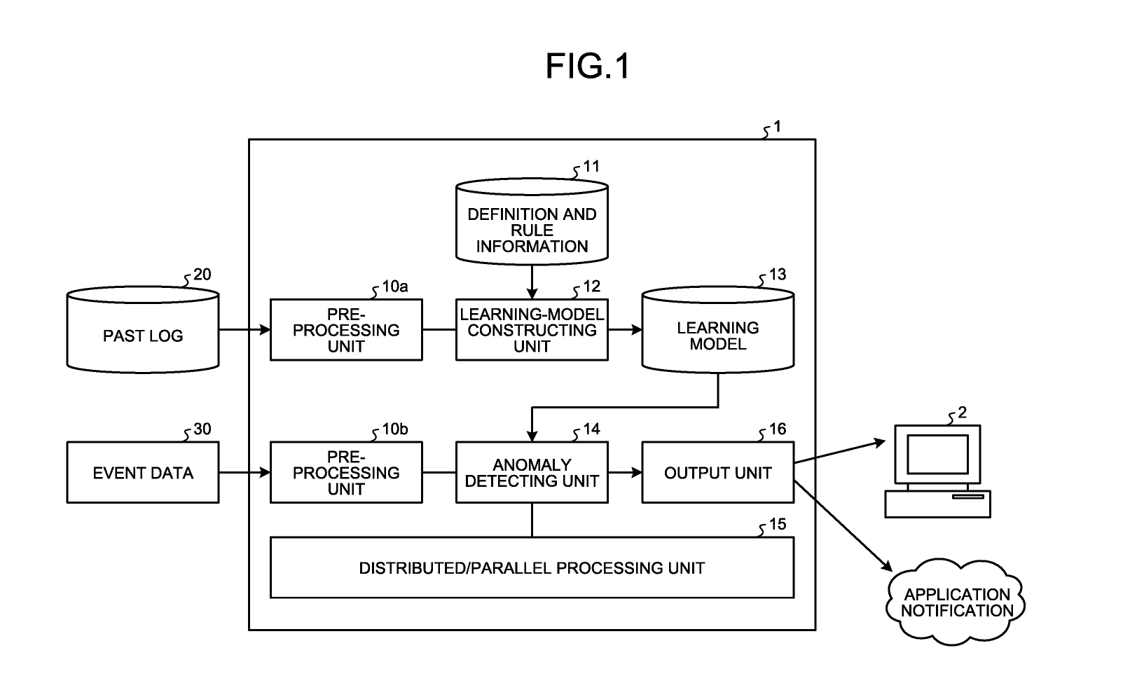

FIG. 1 is a block diagram illustrating a configuration example of a detection apparatus 1 according to an embodiment. The detection apparatus 1 illustrated in FIG. 1 is an information processing unit, for example, a personal computer (PC).

The detection apparatus 1 reads a past log 20 in which events having occurred in the past in a monitoring target system (not illustrated) such as a large-scale computer system or a network system are described in chronological order, to construct a learning model 13. The detection apparatus l receives event data 30 input according to an event that has occurred in real time in the monitoring target system, detects abnormality (anomaly) in the monitoring target system based on the constructed learning model 13 and a collation result with the event data 30, and notifies a user of a detection result. For example, the detection apparatus 1 outputs the detection result of anomaly detection to another terminal device 2 and a predetermined application, and notifies the user of the detection result by a display of the detection result in the terminal device 2 or via application notification.

With regard to the events in the past log 20 and the event data 30, various events can be mentioned, and are not particularly limited. For example, when a cyberattack to the monitoring target system is to be detected as anomaly, there are events such as e-mail reception, e-mail operation, PC operation, website access, data communication, and the like. Further, when illegal access to the monitoring target system is to be detected as anomaly, there are events such as user's behaviors detected based on images of a monitoring camera or an operation of a card key. When environmental abnormality in the monitoring target system is to be detected as anomaly, there are events such as a temperature and a humidity detected by a sensor.

In the present embodiment, the detection apparatus 1 that detects a cyberattack to the monitoring target system as anomaly is exemplified. Therefore, it is assumed that e-mail reception, e-mail operation, PC operation, website access, data communication, and the like are included in the past log 20 and the event data 30.

As illustrated in FIG. 1, the detection apparatus 1 includes a pre-processing units 10a and 10b, definition and rule information 11, a learning-model constructing unit 12, the learning model 13, an anomaly detecting unit 14, a distributed/parallel processing unit 15, and an output unit 16.

The pre-processing units 10a and 10b perform pre-processing such as data shaping/processing with respect to the input data. The pre-processing unit 10a performs pre-processing with respect to the past log 20 input from the monitoring target system, and outputs the processed data to the learning-model constructing unit 12. The pre-processing unit 10b performs pre-processing with respect to the event data 30 input from the monitoring target system, and outputs the processed data to the anomaly detecting unit 14. The pre-processing units 10a and 10b can have a configuration that shares one pre-processing unit without dividing the processing for the past log 20 and the event data 30.

As the pre-processing with respect to the past log 20 and the event data 30, there is a conversion process in which contents of respective events included in the past log 20 and the event data 30 are grouped according to preset conditions and converted to numerals or characters. Accordingly, for example, when contents of respective events included in the past log 20 and the event data 30 are the same with each other, the contents are converted to the same numeral or character by the pre-processing performed by the pre-processing units 10a and 10b.

The definition and rule information 11 is information indicating definitions and rules with regard to the construction of the learning model 13. The definition and rule information 11 preset by a user is stored in a storage device such as a memory. The learning-model constructing unit 12 constructs the learning model 13 according to the definition and rule information 11 based on the pre-processed past log 20. The constructed learning model 13 is stored in a storage device such as a memory. The anomaly detecting unit 14 collates the learning model 13 constructed based on the past log 20 with the pre-processed event data 30, to detect an event occurring in real time in the monitoring target system, that is, abnormality (anomaly) in the current state of the monitoring target system. The anomaly detecting unit 14 outputs a detection result to the output unit 16. The output unit 16 Outputs the detection result obtained by the anomaly detecting unit 14 to the terminal device 2 or a predetermined application.

The distributed/parallel processing unit 15 distributes or parallelizes the respective processes in the detection apparatus 1 by using a plurality of threads. For example, the distributed/parallel processing unit 15 distributes or parallelizes the processes associated with anomaly detection in the anomaly detecting unit 14. In this manner, by distributing or parallelizing the processes in the anomaly detecting unit 14, anomaly detection can be performed at a high speed, and real-time properties of the anomaly detection can be improved.

Distribution/parallellization performed by the distributed/parallel processing unit 15 can be applied to respective processes in the pre-processing units 10a, 10b and the learning-model constructing unit 12.

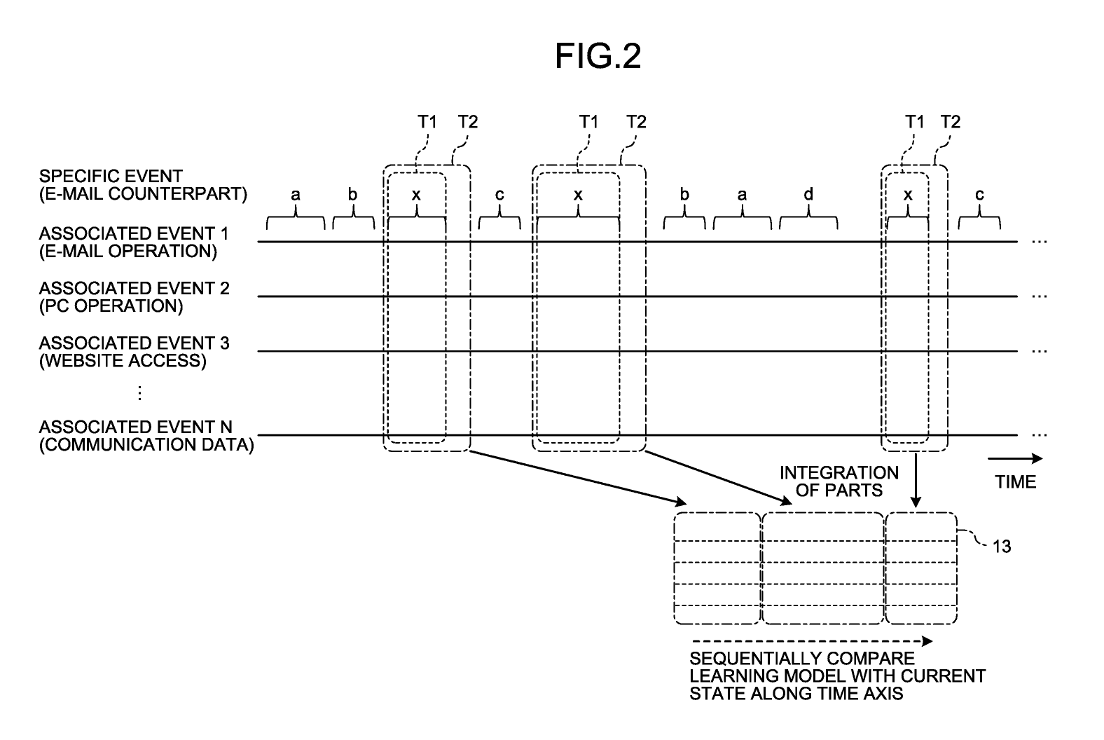

FIG. 2 is an explanatory diagram of an outline of construction of the learning model 13 and the anomaly detection. In an upper stage of FIG. 2, respective events included in the past log 20 are illustrated in chronological order. It is assumed here that e-mail counterparts (a, b, . . . ) have no relation with the exchanging type targeted e-mail attack, and an e-mail counterpart (x) is an attacker who performs the exchanging type targeted e-mail attack. It is also assumed that a time period T1 indicates a time period of an e-mail operation corresponding to reception of an e-mail from a predetermined e-mail counterpart (in the illustrated example, the e-mail counterpart x). Further, it is assumed that a time period T2 is a time period until all the events associated with the e-mail operation corresponding to reception of the e-mail from the predetermined e-mail counterpart (in the illustrated example, the e-mail counterpart x) finish (also referred to as “associated period”).

As illustrated in FIG. 2, the learning-model constructing unit 12 extracts a predetermined event (in the illustrated example, e-mail reception for each e-mail counterpart, and referred to as “specific event” or “primary axis”) among events included in the past log 20, by referring to the definitions/rules described in the definition and rule information 11. Specifically, the learning-model constructing unit 12 extracts a specific event (a primary axis) of e-mail reception for each of the e-mail counterparts (a, b, . . . , x). Subsequently, the learning-model constructing unit 12 extracts a plurality of associated events associated with the specific event indicated in the definitions and rules described in the definition and rule information 11, for a predetermined time width starting from the specific event.

For example, when 1 to N associated events such as e-mail operation, PC operation, website access, and communication data are indicated in the definitions and rules, the learning-model constructing unit 12 extracts the specific event and the associated events (1 to N) over the time period T2 until all the events finish. The time width in which extraction of the specific event and the associated events is performed (for example, the time period T2) is also referred to as “part” in the description below. The learning-model constructing unit 12 extracts the specific event and the associated events for each part corresponding to the specific event.

The learning-model constructing unit 12 then creates pattern data (hereinafter, also as “anomaly pattern”) corresponding to the contents of the specific event and the associated events extracted over the time period T2. Specifically, the learning-model constructing unit 12 creates an anomaly pattern in which values converted by numerals or characters by the pre-processing corresponding to the contents of the specific event and the associated events are arranged in chronological order.

In the creation of the anomaly pattern of respective parts, the learning-model constructing unit 12 creates the anomaly pattern for each event in the specific event and the associated events in a form in which these patterns are in alignment with each other in terms of time. Specifically, the learning-model constructing unit 12 performs predetermined masking for an insubstantial event at a certain timing that is in the specific event and the associated events, based on a preset masking rule for each event in the definition and rule information 11. Accordingly, the anomaly pattern for each event is created in the form in which these patterns are in alignment with each other in terms of time.

For example, when website access accompanied by a PC operation has been performed, an anomaly pattern corresponding to a content of implementation is generated at the same timing in the PC operation and website access of the associated events. On the other hand, when website access not accompanied by the PC operation has been performed, the PC operation is not substantial at the timing when the website access is performed, and the anomaly patterns cannot be in alignment with each other in terms of time. Therefore, with regard to the insubstantial PC operation, the anomaly patterns are created in the form in which the anomaly patterns are in alignment with each other in terms of time, by covering the insubstantial PC operation with the masking pattern based on the preset masking rule.

The learning-model constructing unit 12 constructs the learning model 13 by connecting (integrating) the anomaly patterns in respective parts for each specific event in chronological order. For example, the learning-model constructing unit 12 connects (integrates) the anomaly patterns in respective parts in chronological order for each e-mail reception from the e-mail counterpart (x) to construct the learning model 13 of the e-mail counterpart (x). Similarly, for the e-mail counterparts (a, b, . . . ), the learning-model constructing unit 12 connects (integrates) the anomaly patterns in respective parts in chronological order for each e-mail reception to construct the learning model 13 of the e-mail counterparts (a, b, . . . ).

The e-mail counterpart (x) is an attacker who performs an exchanging type targeted e-mail attack. Therefore, in the case of supervised learning, the learning-model constructing unit 12 constructs the learning model 13 in which respective parts are connected (integrated) in chronological order for the e-mail counterpart (x), as a pattern to detect anomaly (a detection pattern). Further, the learning-model, constructing unit 12 constructs the learning model 13 in which respective parts are connected (integrated) in chronological order for the e-mail counterparts (a, b, . . . ), as a normal pattern to be excluded from anomaly detection (an exclusion pattern).

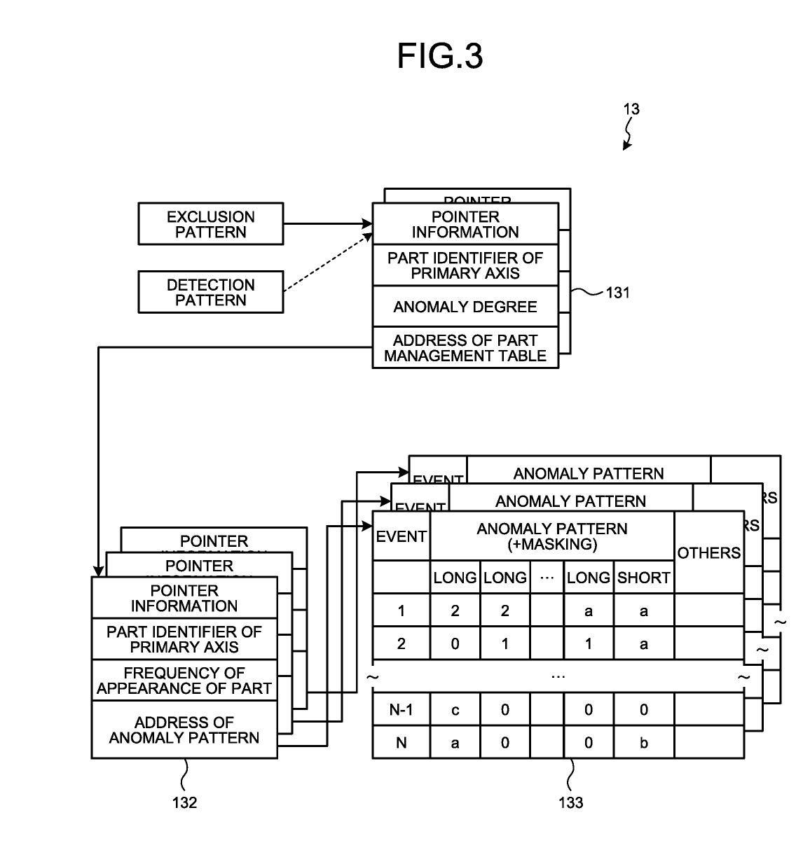

FIG. 3 is an explanatory diagram of the learning model 13. As illustrated in FIG. 3, the learning model 13 includes a part-group management table 131 for managing part groups (respective parts) for each specific event, a part management table 132 for managing pieces of information of each part, and an anomaly pattern 133 of each part.

The part-group management table 131 is a table for controlling and managing the pieces of information of respective parts for each specific event (a primary axis) of e-mail reception from the e-mail counterparts (a, b, . . . x), and includes, for example, pointer information, part identifier of the primary axis, anomaly degree, and address of a part management table.

The pointer information has information indicating an address of each part-group management table 131 stored therein. For example, in the part-group management table 131 with regard to the e-mail counterpart (x) who performs an exchanging type targeted e-mail attack, an address referred to as “detection pattern” is described in the pointer information. Further, in the part-group management table 131 with regard to the e-mail counterparts (a, b, . . . ) who exchange normal e-mails, an address referred to as “exclusion pattern” is described in the pointer information.

In the part identifier of the primary axis, a value uniquely allocated in order to identify a specific event (primary axis) is stored. For example, a value combining an ID of an e-mail counterpart (for example, an e-mail address) with an ID of an e-mail proposition (for example, an e-mail title) is stored in the part identifier. Accordingly, for an e-mail exchanged in the exchanging type targeted e-mail attack, the same part identifier is stored. A value indicating the frequency of appearance of a specific event in the past log 20 is stored in the anomaly degree. An address indicating the part management table 132 for managing the pieces of information of each part is stored in the address of the part management table.

The part management table 132 is a table in which pieces of information for respective parts are controlled and managed, and includes, for example, pointer information, part identifier of the primary axis, the frequency of appearance of each part, and address of the anomaly pattern. An address indicating the next part connected in chronological order is stored in the pointer information. Accordingly, by referring to the pointer information in the part management table 132, pieces of information for respective parts connected in chronological order can be sequentially referred to along a time axis. A value indicating the frequency of appearance of the part appearing in the past log 20 is stored in the frequency of appearance of the part. An address indicating the anomaly pattern 133 in a target part is stored in the address of the anomaly pattern.

Referring back to FIG. 2, the anomaly detecting unit 14 performs comparison of the constructed learning model 13 with the event data 30 input according to the

generated event, that is, comparison (collation) of the constructed learning model 13 with the current state of the system sequentially along the time axis, to detect anomaly (abnormality). For example, if the current state of the system matches the learning model 13 constructed as the detection pattern, the anomaly detecting unit 14 detects that anomaly corresponding to the detection pattern has occurred. If the current state of the system does not match the learning model 13 constructed as the exclusion pattern, the anomaly detecting unit 14 detects that some anomaly deviated from the normal state has occurred. As an example, if the learning model 13 in which parts with regard to the e-mail counterpart (x) who performs an exchanging type targeted e-mail attack are integrated matches the current state of the system, the anomaly detecting unit 14 performs anomaly detection associated with the exchanging type targeted e-mail attack.

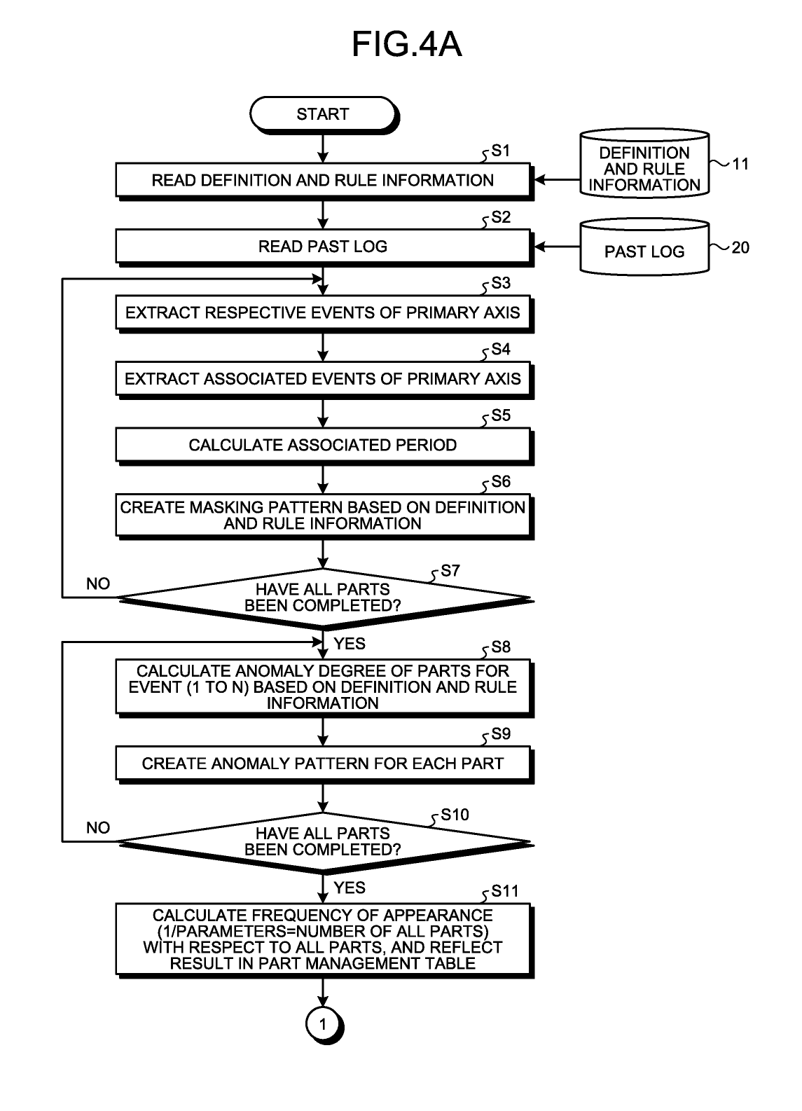

Details of a process associated with the construction of the learning model 13 are described here. FIG. 4A and FIG. 4B are flowcharts illustrating an example of the process associated with the construction of the learning model 13. FIG. 4B is a flowchart of the process following the process in FIG. 4A.

As illustrated in FIG. 4A, when the process is started, the learning-model constructing unit 12 reads of the definition and rule information 11 stored in the memory or the like (S1).

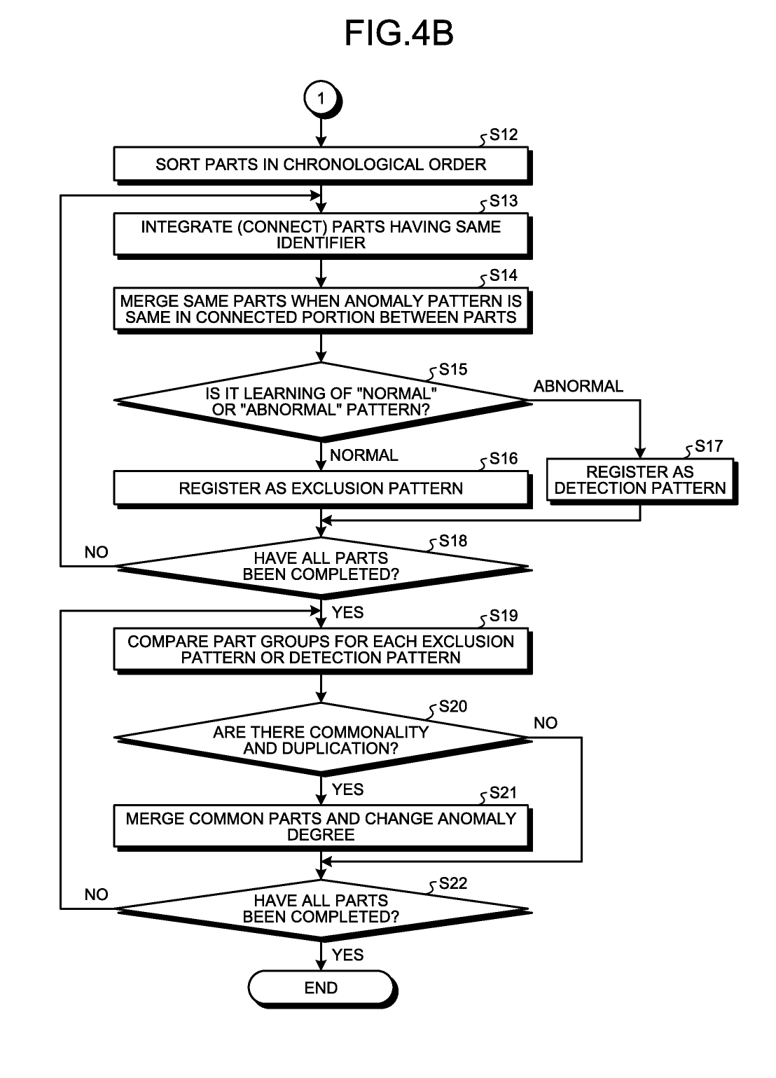

FIG. 5 is an explanatory diagram of the definition and rule information 11. As illustrated in FIG. 5, the definition and rule information 11 includes information such as application rules to the respective events, with regard to the specific event as the primary axis and the associated events associated with the specific event (events in 1 to N).

For example, the application rules to the respective events include rules of a starting point indicating occurrence of an event and an end point indicating an end of the event, and a rule corresponding to the event is set beforehand. The application rules also include a rule for masking (a masking pattern) for creating the anomaly patterns in the form in which these patterns are in alignment with each other in terms of time in the respective events. With regard to the masking rule, for example, there are applications of (a): wild card (match), (b): padding (extension of the front portion), and (c): 0 (NULL), and a rule corresponding to the event is set beforehand. The application rules also include a rule for calculating anomaly (calculating the frequency of appearance) in the respective events, and a calculation method corresponding to the event is set beforehand.

The learning-model constructing unit 12 then read the past log 20 (S2) and extracts the respective events of the primary axis (respective specific events) indicated in the definition and rule information 11 from the past log 20 by referring to a process name or the like of the process described in. the past log 20 for each event (S3). The learning-model constructing unit 12 then extracts the associated events of the primary axis indicated in the definition and rule information 11 from the past log 20, starting from the respective events of the primary axis extracted at S3 (S4).

The learning-model constructing unit 12 calculates the associated period until the event of the primary axis and all the associated events finish, that is, the time width of the respective parts, for each event of the primary axis (a specific event) (S5). Specifically, the learning-model constructing unit 12 checks a logical relationship of the processes such as switching of the process and tracks the process in the event of the primary axis and the associated, events. The learning-model constructing unit 12 then obtains an end point of the process in the event of the primary axis and the associated events based on the rule of the end point indicated in the definition and rule information 11 for each event. The learning-model constructing unit 12 sets the end point with respect to the starting point, which is the longest among the obtained end points, as the end point of the associated period. The learning-model constructing unit 12 refines the events extracted at S3 and S4 to those within the calculated associated period, and extracts the event in each part.

The learning-model constructing unit 12 creates a masking pattern for each event in each part based on the definition and rule information 11 (S6). Specifically, the learning-model constructing unit 12 creates the masking pattern according to the rule corresponding to the event, by referring to the masking rule ((a), (b), or (c)) for each event in the definition and rule information 11. Accordingly, the anomaly pattern 133 in the insubstantial period is covered by the masking pattern created at S6 for the respective events in the associated period. Consequently, the respective events in the anomaly pattern 133 can be created in the form in which these patterns are in alignment with each other in terms of time.

The learning-model constructing unit 12 then determines whether the process at S3 to S6 has been completed for all the parts (S7). If the process for all the parts has not been completed (NO at S7), the learning-model constructing unit 12 returns the process to S3, and performs the process for the next part for which the process has not been completed yet.

If the process for all the parts has been completed (YES at S7), the learning-model constructing unit 12 calculates the anomaly degree (the frequency of appearance) for each event (1 to N) in the part based on the anomaly calculation rule in the definition and rule information 11 (S8). Subsequently, the learning-model constructing unit 12 arranges the values obtained by converting the contents of events extracted for each part by numerals or characters in the pre-processing in chronological order, to create the anomaly pattern 133 in each part (S9). The learning-model constructing unit 12 creates the anomaly pattern 133 for the insubstantial period by covering the anomaly pattern 133 with the masking pattern created at S6.

The learning-model constructing unit 12 creates the part management table 132 added with the part identifier for each part, and stores the address of the anomaly pattern 133 created at S9 in the part management table 132.

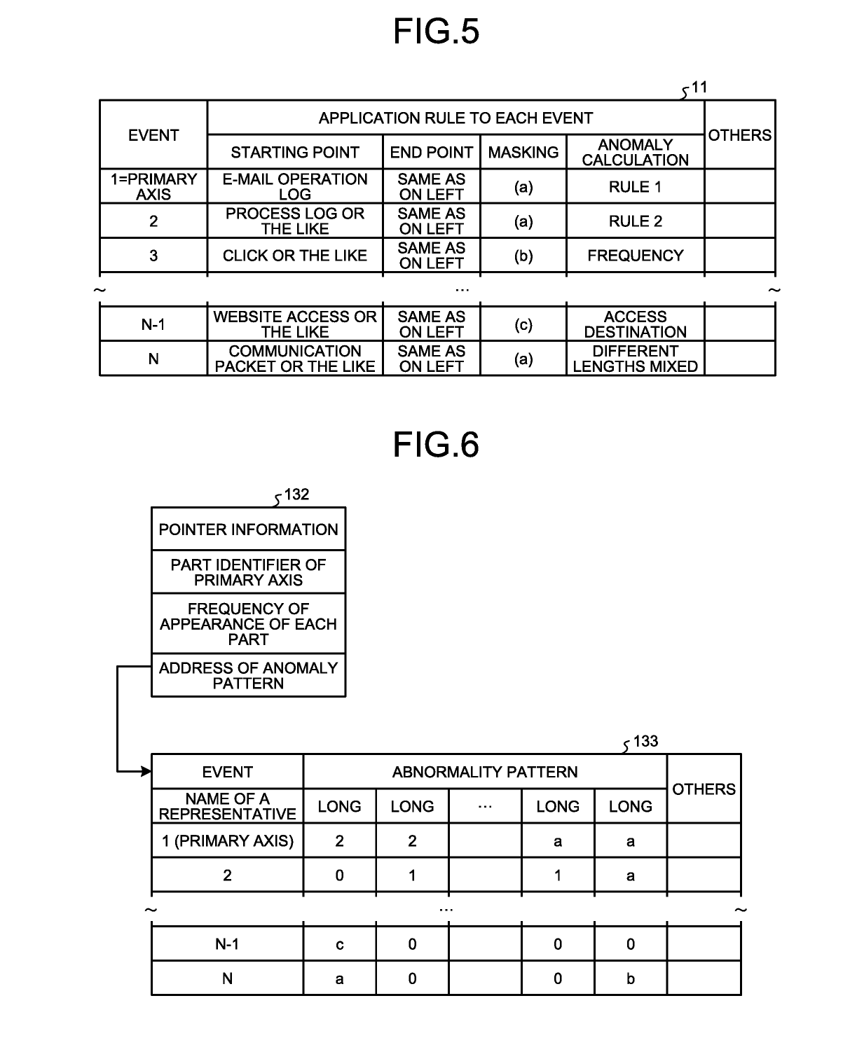

FIG. 6 is an explanatory diagram of the part management table 132 and the anomaly pattern 133. As illustrated in FIG. 6, the learning-model constructing unit 12 creates the part management table 132 added with the part identifier in which an ID of an e-mail counterpart (for example, an e-mail address) and an ID of an e-mail proposition (for example, an e-mail title) are combined with each other. Subsequently, the learning-model constructing unit 12 stores the address of the anomaly pattern 133 created at S9 in the part management table 132.

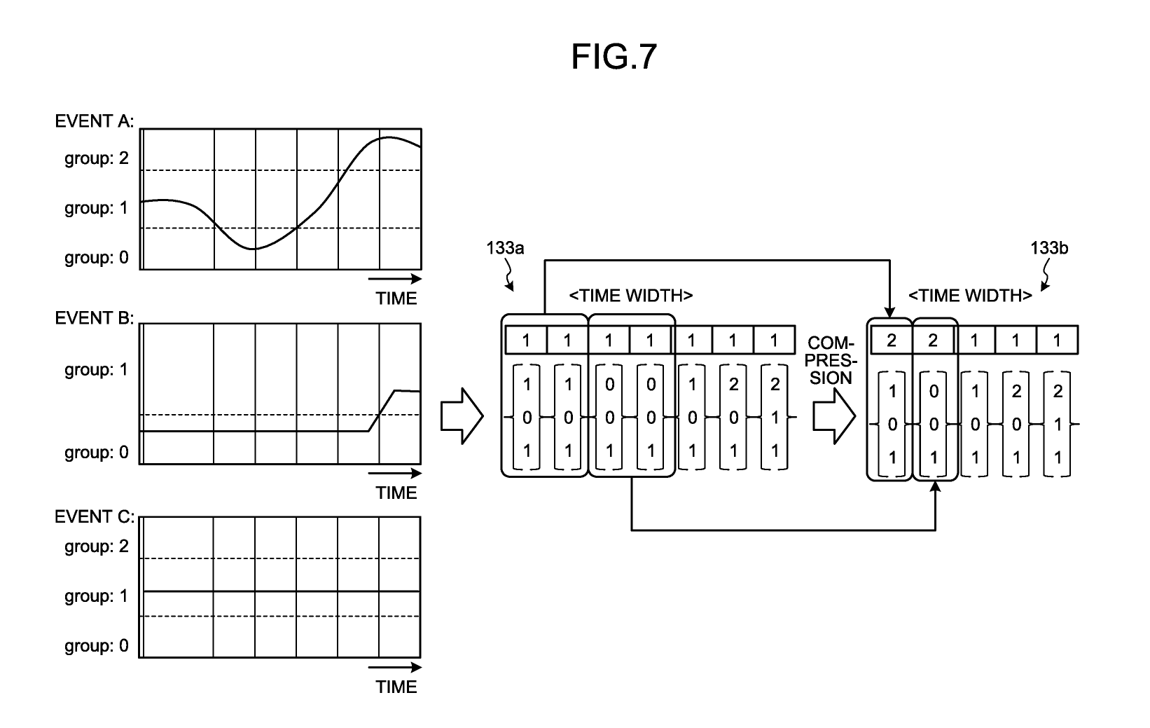

The learning-model constructing unit 12 can compress the anomaly pattern 133 in each part by the time axis and store the address of the compressed anomaly pattern 133 in the part management table 132. FIG. 7 is an explanatory diagram of compression of the anomaly pattern 133.

In FIG. 7, an anomaly pattern 133a indicates an anomaly pattern before compression and an anomaly pattern 133b indicates an anomaly pattern after compression. With regard to the event associated with the anomaly pattern, it is assumed that there are three events of A to C. It is assumed that the event A is converted to any value of 0, 1, and 2 by grouping, and a converted value (an anomaly pattern of the event A) becomes 1, 1, 0, 0, 1, 2, 2 in chronological order. It is assumed that the event B is converted to any value of 0 and 1 by grouping, and an anomaly pattern of the event B becomes 0, 0, 0, 0, 0, 0, 1 in chronological order. Further, it is assumed, that the event C is converted to any value of 0, 1, and 2 by grouping, and an anomaly pattern of the event C becomes 1, 1, 1, 1, 1, 1, 1.

In the anomaly pattern 133a before compression, there is a part of a continuous time width in which the pattern of the events A, B, and, C is (1, 0, 1) or (0, 0, 1). The learning-model constructing unit 12 changes the information indicating the time width of the part of the continuous pattern in the time axis (in the example illustrated in FIG. 7, changed from 1 to 2) and compresses the information. In this manner, the learning-mode1 constructing unit 12 compresses the anomaly pattern 133 by the time axis, to reduce the data amount of the anomaly pattern 133.

Referring back to FIG. 4A, following S9, the learning-model constructing unit 12 determines whether the processes at S8 and S9 have been completed for all the parts (S10). If the processes for all the parts have not been completed yet (NO at S10), the learning-model constructing unit 12 returns the process to S8, and performs the process for the next part for which the process has not been completed yet.

If the processes for all the parts have been completed (YES at S10), the learning-model constructing unit 12 calculates the frequency of appearance with respect to all the parts and reflects the calculated frequency of appearance in the part management table 132 (S11). Specifically, the learning-model constructing unit 12 calculates the frequency of appearance as 1/parameters (=the number of all parts) and stores the calculated frequency of appearance in the frequency of appearance of the part in the part management table 132.

Subsequently, the learning-model constructing unit 12 sorts the parts in chronological order of appearance in the past log 20 (S12), and integrates (connects) the parts added with the same part identifier (S13). Specifically, it is set to refer to the pointer information in the part management table 132 that manages the respective parts in the order in which the parts are sorted at S12. Accordingly, parts extracted for each specific event, for example, e-mail reception for each e-mail counterpart are integrated.

In the part identifier, as an example, a value in which an ID of an e-mail counterpart (for example, an e-mail address) and an ID of an e-mail proposition (for example, an e-mail title) are combined with each other is stored. Therefore, at S13, the e-mail exchanging parts with the same proposition with the same e-mail counterpart, for example, assumed in the exchanging type targeted e-mail attack are integrated in chronological order. Accordingly, it can be suppressed that various different events occurring in the exchange of e-mails assumed in the exchanging type targeted e-mail attack are mixed in the learning model 13. Further, the data amount of the learning model 13 can be reduced as compared to a case where the learning model 13 is constructed based on long-term events from the start to the end of exchange of e mails.

When the anomaly patterns 133 are the same in the connected portion between the parts integrated at S13, the

learning-model constructing unit 12 merges the same parts to compress the data amount (S14). Specifically, as in the compression of the anomaly pattern 133 illustrated in FIG. 7, compression of the parts where the anomaly patterns 133 are the same is performed.

Subsequently, the learning-model constructing unit 12 determines whether it is learning of the “normal” exclusion pattern or learning of an “abnormal” detection pattern by the supervised learning (S15). Specifically, the learning-model constructing unit 12 performs determination of “normal” or “abnormal” based on whether it is the supervised learning by reading the past log 20.

At S15, in the case of “normal”, that is, the learning model 13 is constructed from the e-mail counterparts (a, b, . . . ), the learning-model constructing unit 12 registers the constructed learning model 13 as the exclusion pattern (S16). At S15, in the case of “abnormal”, that is, the learning model 13 is constructed from the e-mail counterpart (x), the learning-model constructing unit 12 registers the constructed learning model 13 as a detection pattern (S17).

Subsequently, the learning-model constructing unit 12 determines whether the processes at S13 to S17 have

been completed for all the parts (S18). If the processes for all the parts have not been completed yet (NO at S18), the learning-model constructing unit 12 returns the process to S13 to perform the process for the next part for which the process has not been completed yet.

If the processes for all the parts have been completed (YES at S18), the learning-model constructing unit 12 compares the part groups of the learning model 13 for each of the exclusion pattern and the detection pattern (S19), to determine the presence of commonality and duplication among the part groups (S20). Specifically, the learning-model constructing unit 12 compares the anomaly patterns 133 of the part groups with each other, and a part where the entire part groups match each other or some portions in the middle of the part groups match each other is determined as a common part having commonality and duplication.

If there are commonality and duplication (YES at S20), the learning-model constructing unit 12 merges the common parts determined to have commonality and duplication and changes the anomaly degree (the frequency of appearance) of the merged parts (S21). Specifically, the learning-model constructing unit 12 adds up the frequency of appearance in the common parts with each other before the merge to obtain the abnormality degree of the merged parts, and changes the abnormality degree to a new abnormality degree. If there are no commonality and duplication (NO at S20), the learning-model constructing unit 12 skips S21 and brings the process forward to S22.

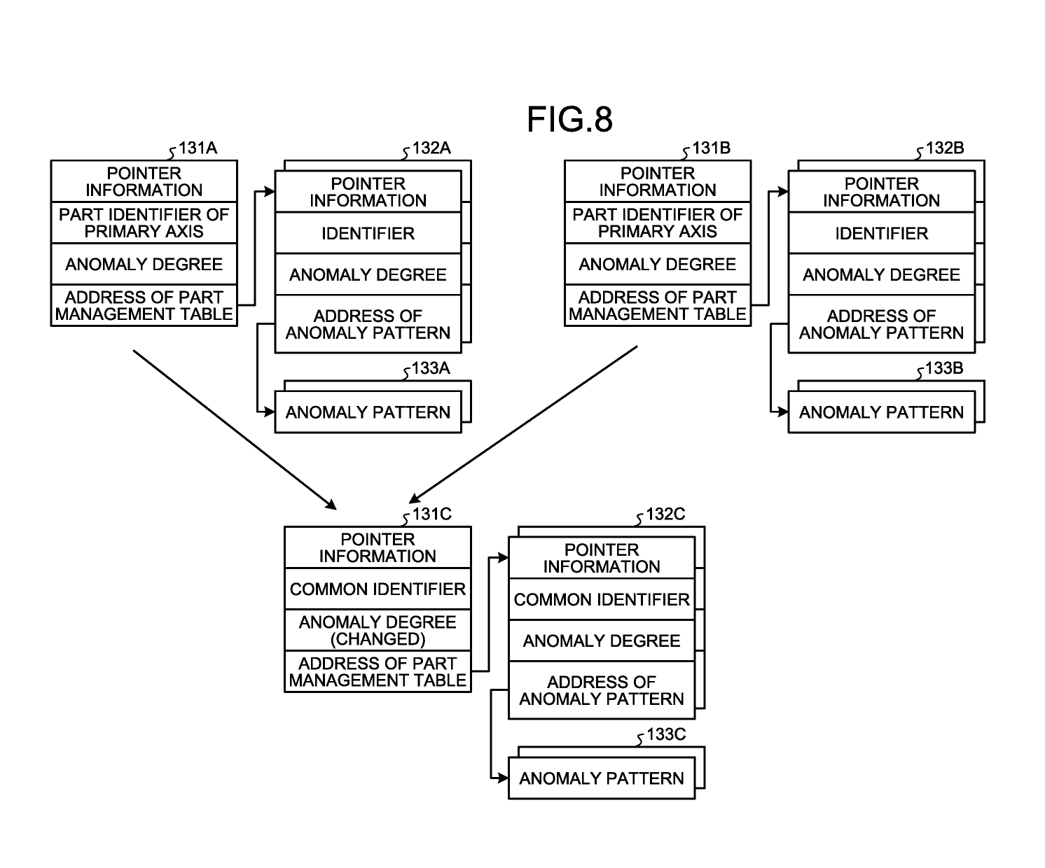

FIG. 8 is an explanatory diagram of merge of the common parts. Specifically, FIG. 8 illustrates merge of common parts in a part group (A) in a part-group management table 131A, a part management table 132A, and an anomaly pattern 133A and a part group (B) in a part-group management table 131B, a part management table 132B, and an anomaly pattern 133B.

As an example, it is assumed that the example illustrated in FIG. 8 is part groups (A, B) in the learning model 13 of the detection pattern constructed from the e-mail counterpart (x). It is assumed that the part group (A) is a part group that has received an attack, e-mail after having exchanged three e-mails. It is assumed that the part group (B) is the same as the part group (A) until the third e-mail is received, and the part group (B) is a part group that receives an attack e-mail after having received the fourth e-mail different from that of the part group (A).

In this manner, when there is the anomaly pattern 133 (a common part) in which three e-mails are exchanged, the learning-model constructing unit 12 merges the part groups (A, B) in the learning model 13 to create a part-group management table 131C, a part management table 132C, and an anomaly pattern 133C in which duplication of the common part is removed. As for the identifier of the part-group management table 131C, the part management table 132C, and the anomaly pattern 133C, a common identifier (for example, part identifier of the part group (A)+part-identifier of the part group (B)) is newly added thereto. In this manner, the learning-model constructing unit 12 can reduce the data amount of the learning model 13 by merging the anomaly pattern 133 (the common part) in the part groups.

Subsequently, the learning-model constructing unit 12 determines whether the process at S19 to S21 has been completed for ail the parts (S22). If the processes at S19 to S21 have not been completed for all the parts (NO at S22), the learning-model constructing unit 12 returns the process to S19 to perform the process for the next part for which the process has not been completed yet. If the processes at S19 to S21 have been completed for all the parts (YES at S22), the learning-model constructing unit 12 finishes the process associated with construction of the learning model 13.

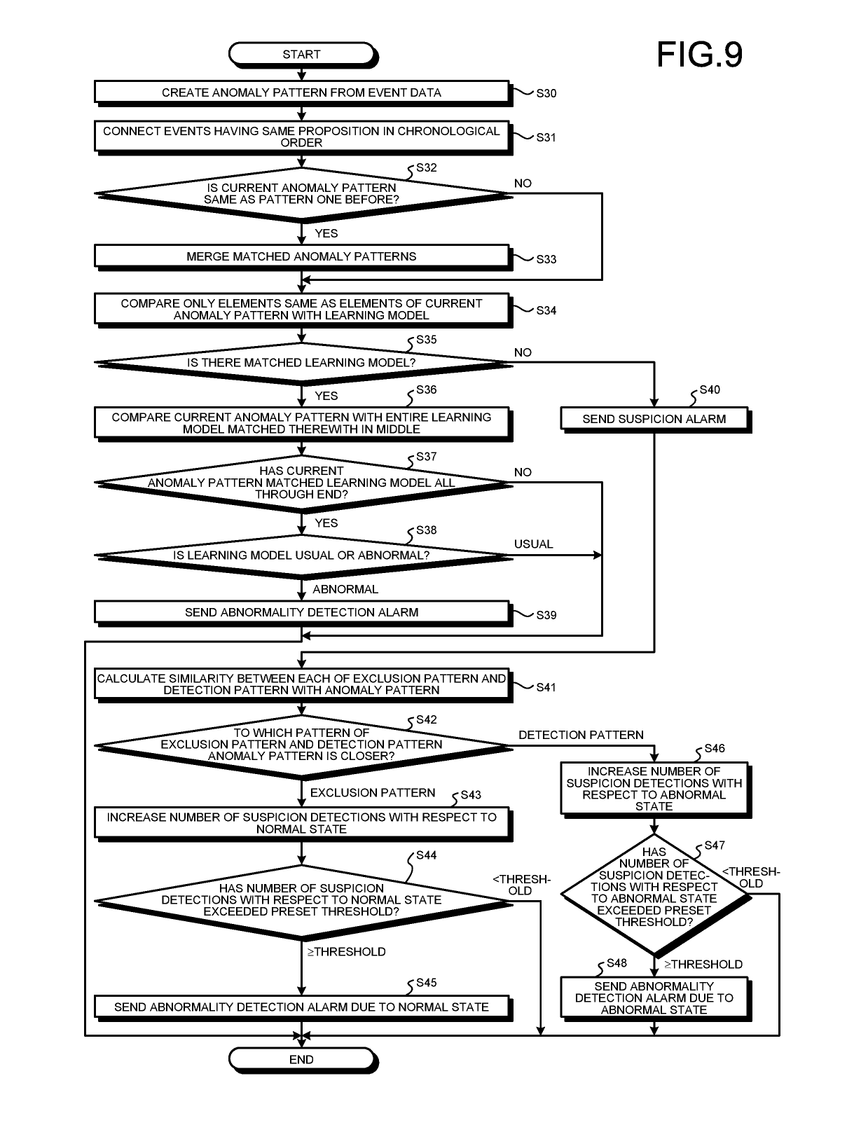

Details of the process associated with anomaly detection are described next. FIG. 9 is a flowchart illustrating an example of the process associated with anomaly detection.

As illustrated in FIG. 9, when the process is started, the anomaly detecting unit 14 creates pattern data (an anomaly pattern) corresponding to the event occurring in real time in the monitoring target system based on the event data 30 after the pre-processing (S30). It is assumed that the anomaly pattern has been subjected to masking based on the definition and rule information 11. The anomaly detecting unit 14 then connects the events having the same proposition (for example, e-mail reception for each of the e-mail counterparts (a, b, . . . , x) in chronological order (S31).

Subsequently, the anomaly detecting unit 14 determines whether the current anomaly pattern created at S30 and S31 is the same as the pattern one before (S32). If the anomaly pattern is the same as the pattern one before (YES at S32), the anomaly detecting unit 14 merges the matched anomaly patterns (S33). If the anomaly pattern is not the same as the pattern one before (NO at S32), the anomaly detecting unit 14 skips the process at S33.

The anomaly detecting unit 14 compares only elements the same as the elements of the current anomaly pattern with the learning model 13 (S34). The anomaly detecting unit 14 then determines whether there is a matched learning model 13 in the comparison at S34 (S35). If there is no matched learning model 13 (NO at S35), the anomaly detecting unit 14 brings the process forward to S40.

If there is a matched, learning model 13 (YES at S35), the anomaly detecting unit 14 compares the current anomaly pattern with the entire learning model 13 matched therewith in the middle (up to the same elements) (S36). The anomaly detecting unit 14 determines whether the current anomaly pattern matches the learning model 13 all through the end in the comparison at S36 (S37). If the current anomaly pattern does not match the learning model 13 all through the end (NO at 337), it cannot be confirmed that abnormality has occurred in the system by the comparison with the learning model 13. Therefore, the anomaly detecting unit 14 finishes the process without issuing an abnormality detection alarm.

If the current anomaly pattern matches the learning model 13 all through the end (YES at S37), the anomaly detecting unit 14 determines whether the matched learning model 13 is an exclusion pattern indicating a “usual” state or a detection pattern indicating the “abnormal” state (S38). If the learning model 13 indicates the “usual” state at S38, the anomaly detecting unit 14 finishes the process without issuing an abnormality detection alarm.

If the learning model 13 indicates the “abnormal” state at S38, the anomaly detecting unit 14 sends an abnormality detection alarm to the output unit 16 (S39) to finish the process. The output unit 16 having received the abnormality detection alarm outputs abnormality detection to the terminal device 2 and a predetermined application.

When the process is brought forward to S40, because there is no learning model 13 matched with the current anomaly pattern, it means that there is no match with not only the detection pattern indicating the “abnormal” state but also the exclusion pattern indicating the “usual” state. Therefore, at S40, the anomaly detecting unit 14 sends a suspicion alarm indicating that the state is not “abnormal” but suspicious to the output unit 16. The output unit 16 having received the suspicion alarm outputs the suspicion alarm to the terminal device 2 and a predetermined application,

The anomaly detecting unit 14 calculates similarity between the exclusion pattern and the detection pattern in the learning model 13 and the anomaly pattern created at S30 and S31 (S41). Specifically, by using a known method associated with pattern matching, a similarity degree of respective patterns is obtained.

The anomaly detecting unit 14 determines to which pattern of the exclusion pattern and the detection pattern the anomaly pattern created at S30 and S31 is closer, based on the calculated similarity degree (S42). If the anomaly pattern is closer to the exclusion pattern at S42, the current state of the system is similar to the normal pattern. Therefore, the anomaly detecting unit 14 increases the number of suspicion detections with respect to the normal state (S43).

The anomaly detecting unit 14 determines whether the number of suspicion detection with respect to the normal state exceeds a preset threshold (S44). If the number of suspicion detection with respect to the normal state exceeds the preset threshold (S44: ≧threshold), the anomaly detecting unit 14 sends an abnormality detection alarm due to the normal state to the output unit 16, because the abnormality degree is high (S45). The output unit 16 having received the abnormality detection alarm outputs abnormality detection to the terminal device 2 and a predetermined application.

If the anomaly pattern is closer to the detection pattern at S42, the current state of the system is similar to the abnormal pattern. Therefore, the anomaly detecting unit 14 increases the number of suspicion detections with respect to the abnormal state (S46). The anomaly detecting unit 14 determines whether the number of suspicion detections with respect to the abnormal state exceeds a preset threshold (S47). If the number of suspicion detections with respect to the abnormal state exceeds the preset threshold (S47: ≧threshold), the anomaly detecting unit 14 sends an abnormality detection alarm due to the abnormal state to the output unit 16, because the abnormality degree is high (S48). The output unit 16 having received the abnormality detection alarm outputs abnormality detection to the terminal device 2 and a predetermined application.

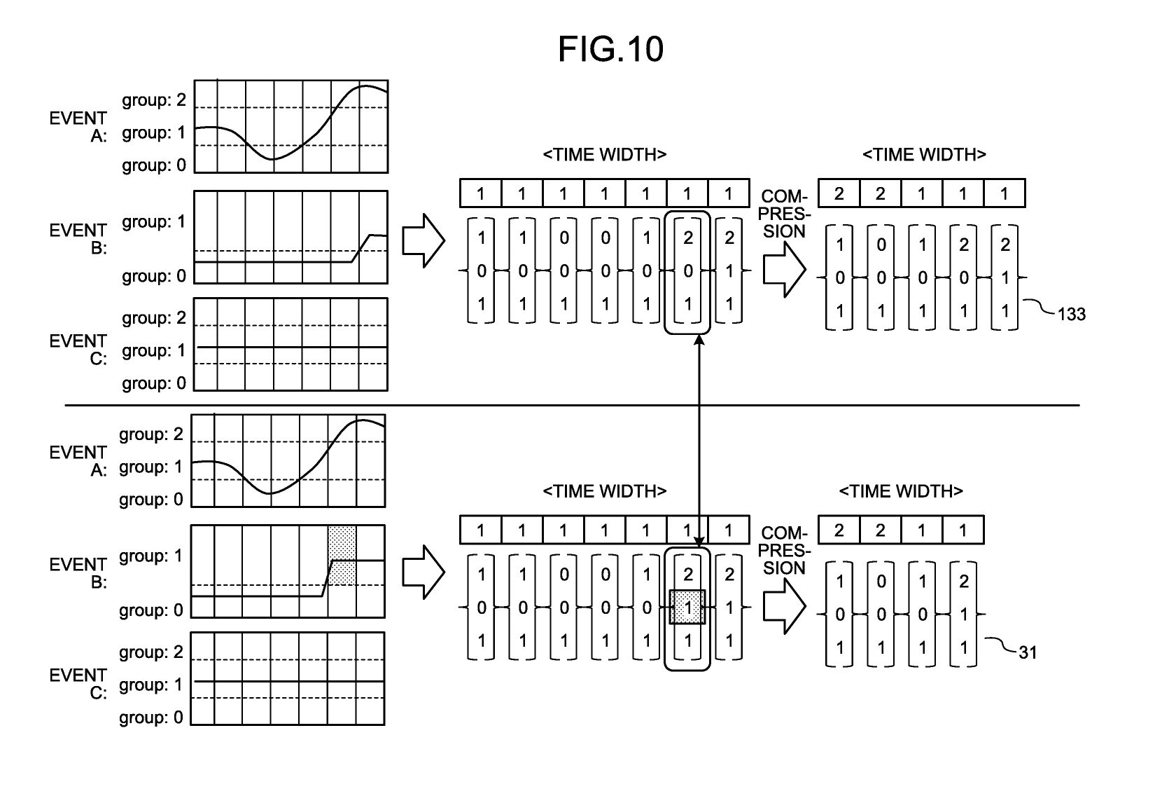

FIG. 10 is an explanatory diagram of an example of abnormality detection. In FIG. 10, an example of the anomaly pattern 133 included in the learning model 13 of the exclusion pattern is illustrated in an upper stage. An example of an anomaly pattern 31 created at S30 and S31 is illustrated in a lower stage. As illustrated in FIG. 10, for example, if the anomaly pattern 31 indicating the current state of the system created at S30 and S31 does not match the anomaly pattern 133 of the exclusion pattern (in a case of not matching), the anomaly detecting unit 14 outputs a suspicion alarm in the system. When the number of suspicion detections with respect to the normal state has exceeded the preset threshold, the anomaly detecting unit 14 outputs an abnormality detection alarm due to the normal state.

As described above, based on the definition and rule information 11, the detection apparatus 1 extracts a specific event among events included in the past log 20, and extracts a plurality of associated events associated with the specific event, for each specific event, over a predetermined time width designating the specific event as a starting point. The detection apparatus 1 also creates the anomaly pattern 133 corresponding to the specific event and the associated events for each specific event, based on the definition and rule information 11. Further, the detection apparatus 1 constructs the learning model 13 in which the anomaly patterns 13 3 created for each specific event are connected in chronological order of the specific events, based on the definition and rule information 11. The anomaly detecting unit 14 of the detection apparatus 1 detects abnormality (anomaly) based on a collation result between the learning model 13 and the event data 30 input according to the occurring event.

In this manner, the learning model 13 associated with anomaly detection is constructed by extracting the specific event and the associated events over the predetermined time width designating the specific event as a starting point from the past log 20. Therefore, it can be suppressed that various different events occurring between the specific events are mixed in the learning model 13. Accordingly, the detection apparatus 1 can accurately detect abnormality accompanied by an event occurring intermittently over a long time by detecting anomaly based on the collation result between the constructed learning model 13 and the event data 30.

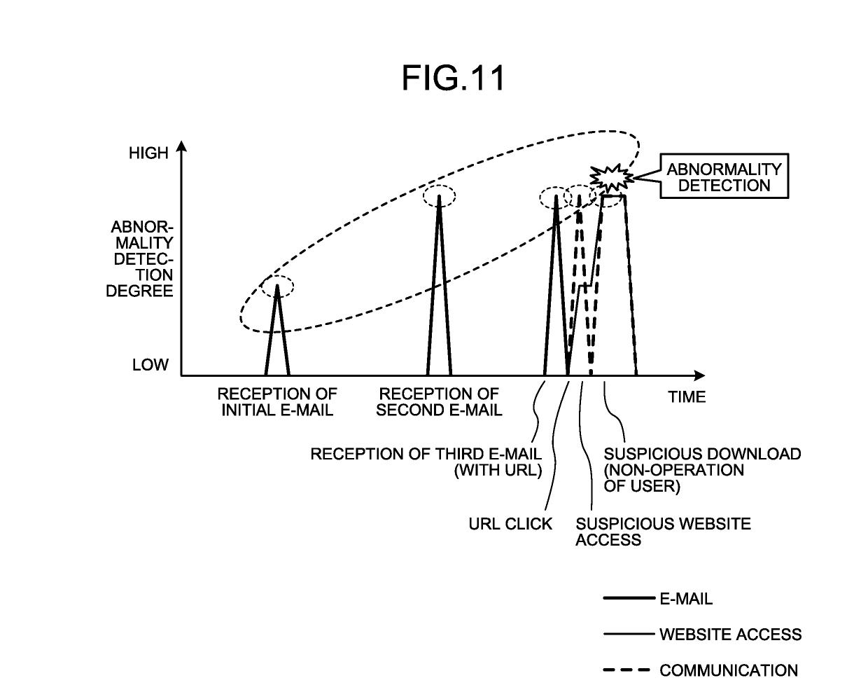

FIG. 11 is an explanatory diagram of abnormality detection in an exchanging type targeted e-mail attack. As illustrated in FIG. 11, the detection apparatus 1 can accurately detect abnormality (anomaly) in the exchanging type targeted e-mail attack accompanied by an event occurring intermittently over a long time.

It is not always requisite that respective constituent elements of respective devices illustrated in the drawings have the same configuration physically as illustrated in the drawings. That is, the specific mode of distribution and integration of the respective devices is not limited to the illustrated one, and all or a part thereof can be functionally or physically distributed or integrated in an arbitrary unit, according to various kinds of load and the status of use.

For example, while the device configuration of a stand-alone detection apparatus 1 has been exemplified in the present embodiment, the device can be configured by cloud computing in which a plurality of storage devices and server devices are connected via a network.

Furthermore, all or an arbitrary part of each processing function performed by detection apparatus 1 can be realized by a CPU (or a microcomputer such as a MPU and a MCU (Micro Controller Unit)). In addition, it is needless to say that all or an arbitrary part, of each processing function can be realized by a program analyzed and executed in the CPU, or a microcomputer such as a MPU and a MCU, or realized as hardware by a wired logic.

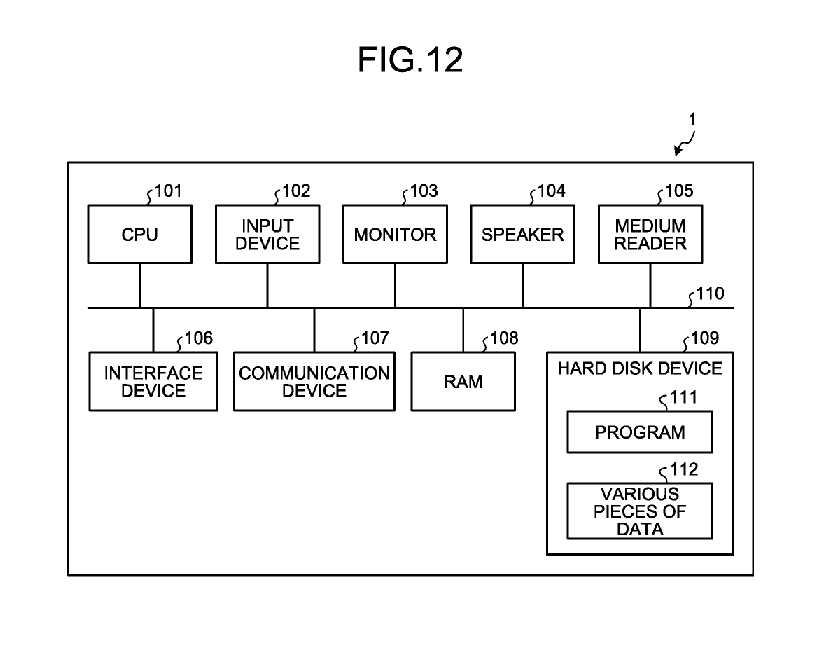

The various processes described in the embodiment described above can be realized by executing a program prepared beforehand by a computer. Therefore, an example or a computer (hardware) that executes a program having the same functions as those of the embodiment described above is described. FIG. 12 is a block diagram illustrating an example of a hardware configuration of the detection apparatus 1 according to the present embodiment.

As illustrated in FIG. 12, the detection apparatus 1 includes a CPU 101 that performs various types of arithmetic processing, an input device 102 that receives data input, a monitor 103, and a speaker 104. The detection apparatus 1 also includes a medium reader 105 that reads a program and the like from a memory medium, an interface device 106 for connecting to various devices, and a communication device 107 for performing communication connection with an external device by wired or wireless connection. Further, the detection apparatus 1 includes a RAM 108 for temporarily storing various pieces of information and a hard disk device 109. The respective units (101 to 109) in the detection apparatus 1 are connected to a bus 110.

A program 111 for performing various processes in the pre-processing units 10a and 10b, the learning-model constructing unit 12, the anomaly detecting unit 14, the distributed/parallel processing unit 15, and the output unit 16 described in the embodiment described above is stored in the hard disk device 109. Various pieces of data 112 referred to by the program 111 (the learning model 13, the past log 20, and the event data 30) are also stored in the hard disk device 109. The input device 102 receives an input of operation information, for example, from an operator of the detection apparatus 1. The monitor 103 displays various screens, for example, operated by the operator. To the interface device 106, for example, a printing device is connected. The communication device 107 is connected to a communication network such as a local area network (LAN), to exchange various pieces of information with an external device via the communication network.

The CPU 101 reads the program 111 stored in the hard disk device 109 and develops and executes the program 111 in the RAM 108, to perform various processes. The program 111 does not need to be stored in the hard disk device 109. For example, the detection apparatus 1 can read and execute the program 111 stored in a memory medium readable by the detection apparatus 1. The memory medium readable by the detection apparatus 1 is, for example, a portable recording medium such as a CD-ROM, a DVD disk, or a universal serial bus (USB) memory, a semiconductor memory such as a flash memory, and a hard disk drive. Further, the program 111 can be stored in a device connected to a public line, the Internet, or the LAN, and the detection apparatus 1 can read the program 111 therefrom and execute the program 111.

According to an embodiment of the present-invention, it is possible to detect abnormality accompanied by an intermittent and long-term event.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a detection program that causes a computer to execute a process comprising:
extracting a predetermined event from events included in a past log and extracting a plurality of associated events associated with the predetermined event, for each of the predetermined event, over a predetermined time width designating the predetermined event as a starting point;
creating pattern data corresponding to the predetermined event and the associated events;
constructing a learning model in which the pieces of pattern data are connected in chronological order of the predetermined event; and
detecting abnormality based on a collation result between the learning model and event data input according to an occurring event.

2. The non-transitory computer-readable recording medium according to claim 1, wherein the extracting extracts a time width in which an end point with respect to the starting point becomes longest among the predetermined event and the associated events, based on a rule of the end point preset for each event with respect to the starting point.

3. The non-transitory computer-readable recording medium according to claim 1, wherein the creating masks the pattern data corresponding to the predetermined event and the associated events extracted over the predetermined time width, based on a masking rule preset for each event.

4. The non-transitory computer-readable recording medium according to claim 1, wherein the constructing constructs the learning model, by merging common parts that are common to each other in pieces of pattern data created for each of the predetermined event.

5. A detection method comprising:
extracting a predetermined event from events included in a past log and extracting a plurality of associated events associated with the predetermined event, for each of the predetermined event, over a predetermined time width designating the predetermined event as a starting point by a processor;
creating pattern data corresponding to the predetermined event and the associated events by the processor;
constructing a learning model in which the pieces of pattern data are connected in chronological order of the predetermined event by the processor; and
detecting abnormality based on a collation result between the learning model and event data input according to an occurring event by the processor.

6. The detection method according to claim 5, wherein the extracting extracts a time width in which an end point with respect to the starting point becomes longest among the predetermined event and the associated events, based on a rule of the end point preset for each event with respect to the starting point.

7. The detection method according to claim wherein the creating masks the pattern data corresponding to the predetermined event and the associated events extracted over the predetermined time width, based on a masking rule preset for each event.

8. The detection method according to claim 5, wherein the constructing constructs the learning model, by merging common parts that are common to each other in pieces of pattern data created for each of the predetermined event.

9. A detection apparatus comprising a processor that executes a process comprising:
extracting a predetermined event from events included in a past log and extracting a plurality of associated events associated with the predetermined event, for each of the predetermined event, over a predetermined time width designating the predetermined event as a starting point;
creating pattern data corresponding to the predetermined event and the associated events;
constructing a learning model in which the pieces of pattern data are connected in chronological order of the predetermined event; and
detecting abnormality based on a collation result between the learning model and event data input according: to an occurring event.

10. The detection apparatus according to claim 9, wherein the extracting extracts a time width in which an end point with respect to the starting point becomes longest among the predetermined event and the associated events, based on a rule of the end point preset for each event with respect to the starting point.

11. The detection apparatus according to claim 9, wherein the creating masks the pattern data corresponding to the predetermined event and the associated events extracted over the predetermined time width, based on a masking rule preset for each event.

12. The detection apparatus according to claim 9, wherein the constructing constructs the learning model, by merging common parts that are common to each other in pieces of pattern data created for each of the predetermined event.
